(19) United States
(12) Patent Application Publication
(10) Pub. No.: US 2026/0321714 A1
(43) Pub. Date: Oct. 15, 2026

(54) HIGH RATE PERFORMANCE, HIGH VOLTAGE AND TEMPERATURE STABLE QUASI SOLID STATE LITHIUM BATTERY

(71) Applicant: Hong Kong Applied Science and Technology Research Institute Company Limited, Hong Kong (HK)

(72) Inventors: Qingwen LU, Hong Kong (HK); Soon Yee LIEW, Hong Kong (HK); Yiyang FEI, Hong Kong (HK); Yan Lung WONG, Hong Kong (HK); Jishi YANG, Hong Kong (HK); Wei HUANG, Hong Kong (HK); Shengbo LU, Hong Kong (HK); Chenmin LIU, Hong Kong (HK)

(21) Appl. No.: 19/642,650

(22) Filed: Apr. 9, 2026

Related U.S. Application Data
(60) Provisional application No. 63/786,932, filed on Apr. 10, 2025.

(51) Int. Cl. H01M 10/056; H01M 4/02; H01M 4/38; H01M 4/505; H01M 4/525; H01M 4/58; H01M 4/583; H01M 10/0525; H01M 10/058; H01M 10/42

(52) U.S. Cl. CPC H01M 10/056; H01M 4/382; H01M 4/386; H01M 4/505; H01M 4/525; H01M 4/5825; H01M 4/583; H01M 10/058; H01M 10/4235; H01M 2004/027; H01M 2004/028; H01M 10/0525; H01M 2300/002; H01M 2300/0034; H01M 2300/0037; H01M 2300/0082

(57) ABSTRACT

A lithium-based battery is provided that includes a negative electrode, a separator, a positive lithium-containing electrode, and a quasi-solid-state electrolyte (QSE) formed from an in-situ thermally or radiation-cured precursor mixture containing monomers and a liquid electrolyte. The monomers include a fluoro-moiety-containing monomer and a monomer having multiple cross-linkable arms. Prior to curing, the precursor mixture exhibits a viscosity of less than 10 centipoise (cP) and a surface tension of less than 25 mN/m, enabling complete wetting and infiltration of the electrodes and separator. After curing, the QSE contains 10 wt % or less solids and 90 wt % or more liquid electrolyte. Batteries incorporating the QSE demonstrate stable cycling during charge-discharge operation at 40-50° C., provide cycling performance at least equivalent to liquid-electrolyte batteries over 500 cycles at room temperature, and exhibit comparable rate performance up to a 2 C discharge current with greater than 95% capacity retention.

### CROSS-REFERENCE TO RELATED APPLICATIONS

The present application claims priority from U.S. Provisional Utility Patent application No. 63/786,932 filed Apr. 10, 2025; the disclosure of which is incorporated herein by reference in its entirety.

### FIELD OF THE INVENTION

The present invention generally relates to the field of electrochemical energy storage. More specifically the present invention relates to lithium-based batteries incorporating quasi-solid-state electrolytes.

### BACKGROUND OF THE INVENTION

Lithium-ion batteries are widely used in electric vehicles (EVs) owing to their high energy density and efficient charge-discharge characteristics. Conventional lithium-ion batteries typically employ liquid electrolytes, which provide favorable lithium-ion transport kinetics and excellent wetting of electrodes and separators. However, liquid electrolytes present significant safety concerns due to their flammability and the potential formation of lithium dendrites, which may cause internal short circuits and thermal runaway.

Solid-state electrolytes (SSEs) have been investigated as safer alternatives because they eliminate flammable solvents. Nevertheless, SSEs suffer from several practical limitations, including relatively low ionic conductivity, poor solid-solid interfacial contact with electrode materials, and mechanical rigidity that restricts processability and large-scale manufacturability.

Quasi-solid-state electrolytes (QSEs) offer a promising compromise by combining the advantages of both liquid and solid electrolytes. Such electrolytes typically contain liquid precursors that are polymerized in situ, for example through thermal initiation or high-energy radiation, thereby forming a hybrid electrolyte structure that improves mechanical stability and safety while retaining adequate ionic conductivity. However, many conventional monomers used in QSE systems, particularly those containing hydrocarbon segments and ethylene glycol units, remain inherently flammable. In addition, existing QSE formulations often exhibit high precursor viscosity, which limits effective electrode wetting. Insufficient wetting leads to nonuniform electrolyte distribution, resulting in reduced capacity, poor rate capability, and inferior cycling stability, thereby hindering the practical deployment of quasi-solid-state batteries.

Another important challenge in practical battery operation is maintaining performance under elevated temperature conditions. During charge-discharge cycling at temperatures such as approximately 45° C., conventional liquid electrolytes may undergo accelerated decomposition through side reactions with electrode active materials, leading to rapid capacity fading and shortened service life.

Accordingly, there remains a need in the art for improved quasi-solid-state electrolyte systems for lithium batteries that exhibit enhanced safety, improved electrode wettability, and stable electrochemical performance across a wide temperature range. The present invention addresses these needs.

### SUMMARY OF THE INVENTION

It is an objective of the present invention to provide the device and method to solve the aforementioned technical problems.

In accordance with a first aspect of the present invention, a lithium-based battery is provided. Specifically, the lithium-based battery includes: a negative electrode; a separator; a positive lithium-containing electrode; and a QSE including an in-situ thermally or radiation-cured precursor mixture including monomers and a liquid electrolyte. It is worth noting that the monomers include a fluoro-moiety-containing monomer and a monomer having multiple cross-linkable arms; and the precursor mixture has a viscosity of less than 10 centipoise (cP) and a surface tension of less than 25 mN/m prior to curing such that the precursor mixture fully wets and infiltrates the negative electrode, the positive electrode, and the separator prior to curing. After curing, the cured electrolyte has a solids content of 10 wt % or less and a liquid content of 90 wt % or more.

The lithium-based battery exhibits cycling stability during charge-discharge operation at 40-50° C.; the QSE provides at least equal cycling performance compared to liquid-electrolyte batteries at room temperature for 500 cycles; and the QSE provides comparable rate performance to liquid-electrolyte batteries at up to a 2 C discharge current with greater than 95% capacity retention.

In accordance with one embodiment, the positive electrode includes one or more of lithium iron phosphate, lithium cobalt oxide, lithium nickel cobalt manganese oxide, lithium nickel cobalt aluminum oxide, spinel-based lithium manganese oxide, spinel-based lithium nickel manganese oxide, or lithium-rich manganese oxide.

In accordance with another embodiment, the negative electrode includes one or more of carbon, graphite, or silicon-carbon.

In accordance with yet another embodiment, the negative electrode includes lithium metal.

In accordance with yet another embodiment, the precursor mixture further includes one or more flame retardant phosphate-including monomers.

In accordance with yet another embodiment, the radiation curing includes gamma-ray irradiation or X-ray irradiation.

In accordance with yet another embodiment, the liquid electrolyte includes one or more lithium salts dissolved in one or more solvents.

In accordance with yet another embodiment, the one or more solvents includes one or more of ethylene carbonate (EC), propylene carbonate (PC), dimethyl carbonate (DMC), diethyl carbonate (DEC), ethyl methyl carbonate (EMC), fluoroethylene carbonate (FEC), vinylene carbonate (VC), 1,2-dimethoxyethane (DME), 1,2-dimethoxypropane (1,2-DMP), 1,2-diethoxyethane (DEE), 1,3-dimethoxypropane (1,3-DMP), dimethoxymethane (DMM), diethyleneglycol dimethylether (diglyme or G2), triethyleneglycol dimethylether (triglyme or G3), or tetraethyleneglycol dimethylether (G4).

In accordance with yet another embodiment, the lithium salt includes one or more of lithium hexafluorophosphate (LiPF₆), lithium bis(trifluoromethanesulfonyl)imide (LiTFSI), lithium bis(fluoromethanesulfonyl)imide (LiFSI), lithium tetrafluoroborate (LiBF₄), lithium bis(oxalate) borate (LiBOB), lithium difluoro (oxalate) borate (LiDFOB), lithium difluorophosphate (LiPO₂F₂), lithium nitrate, lithium trifluoromethanesulfonate (LiOTF), or lithium tetrafluoro oxalato phosphate (LTFOP).

In accordance with yet another embodiment, the precursor mixture further includes a thermal polymerization initiator comprising one or more of 2,2′-azobis(2-methylpropionitrile) (AIBN), 1,1′-azobis(cyclohexanecarbonitrile) (ACHBN), 2,2′-azobis(2-methylpropionitrile) (AMPN), 2-(1-cyano-1-methylethyl) azocarboxamide (CMAB), 2,2′-azobis(2,4-dimethylvaleronitrile) (ADMVN), benzoyl peroxide (BPO), tert-butyl peroxide (TPBO), cumene hydroperoxide (CHPO), dicumyl peroxide (DPO), lauroyl peroxide (LPO), tert-butyl peroxybenzoate (TBPBO), di-tert-butyl acetylenedicarboxylate (DTBADB), 1,1-bis(tert-butylperoxy)-3,3,5-trimethylcyclohexane (BTBTMO), tert-butylperoxy 2-ethylhexyl carbonate (TBECO), or tetrabutylphosphonium Persulfate (TPP).

In accordance with yet another embodiment, the precursor mixture further includes a UV-polymerization initiator comprising one or more of 2-hydroxy-2-methylpropiophenone (HMPP), acetophenone (APO), benzophenone (BPHO), 2,2-diethoxyacetophenone (DAPO), camphorquinone (CPQO), 2,2-dimethoxy-2-phenylacetophenone (DMPPO), 1-hydroxycyclohexyl phenyl ketone (HCPO), ipdhenyl (2,4,6-trimethylbenzoyl)phosphine oxide (DPTPP), or phenylbis(2,4,6-trimethylbenzoyl) phosphine oxide (PTBPPO).

In accordance with yet another embodiment, the fluoro-moiety-containing monomer includes one or more of 2,2,2-trifluoroethyl acrylate (TFEA), 2,2,2-trifluoroethyl methacrylate (TFMA), 2,2,3,4,4,4-hexafluorobutyl methacrylate (HFOMA), 1,1,1,3,3,3-hexafluoroisopropyl acrylate (HFPA), 2,2,3,3,4,4,5,5-octafluoropentyl methacrylate (QFMA), 2,2,3,3-tetrafluoropropyl methacrylate (TFPMA), 2,2,3,3,3-pentafluoropropyl methacrylate (PFPMA), 2,2,3,3,4,4,5,5,6,6,7,7-dodecafluoroheptyl acrylate (DFHA), 2,2,3,3,4,4,4-heptafluorobutyl methacrylate (HFBMA), or 3,3,4,4,5,5,6,6,7,7,8,8,8-tridecafluorooctyl acrylate (TFOA).

In accordance with yet another embodiment, the monomer having multiple cross-linkable arms includes one or more of poly(ethylene glycol) diacrylate (PEGDA), poly(ethylene glycol) methacrylate (PEGMA), 1,4-bis(acryloyloxy) butane (BABE), triethylene glycol dimethacrylate (TEGDMA), poly(ethylene glycol) dimethacrylate (PEGDMA), N,N′-methylenebis(acrylamide) (MBA), acrylic anhydride (AA), pentaerythritol tetraacrylate (PETA), 2-((bis((2-oxo-1,3-dioxolan-4-yl) methoxy)phosphoryl)oxy)ethyl acrylate (BDMPEA), trimethylolpropane trimethacrylate (TMPTMA), trimethylolpropane triacrylate (TMPTA), trimethylolpropane ethoxylate triacrylate (TMPETA), tri(acryloyloxyethyl) phosphate (TAEP), triallyl phosphate (TAP), tris(acryloyldioxyethyl) phosphate (TADEP), dipentaerythritol penta-/hexa-acrylate (DPTPHA), ((1,3,5,2λ5,4λ5,6λ5-triazatriphosphinine-2,2,4,4,6,6-hexayl)hexakis(oxy))hexakis(ethane-2,1-diyl) hexaacrylate (CPHEA), or acrylo POSS (A-POSS).

In accordance with yet another embodiment, the precursor mixture further includes one or more of (2-oxo-1,3-dioxolan-4-yl)methyl methacrylate (GCA), 3-(trimethoxysilyl) propyl methacrylate (TMSMA), 3-(trimethoxysilyl) propyl acrylate (TMSPA), methacrylpropylisobutyl POSS (MA-POSS), diethyl allyl phosphate (DAP), diethyl vinylphosphonate (DEVP), 2-methoxyethyl acrylate (EGMEA), poly(ethylene glycol) methyl ether acrylate (PEGMEA), poly(ethylene glycol) methyl ether methacrylate (PEGMAMA), 2-cyanoethyl acrylate (CEA), 2-(methacryloyloxy)ethyl acetoacetate (AAEM), or N,N-dimethylacrylamide (DMAAm).

In accordance with yet another embodiment, the monomer concentration in the precursor mixture is from 0.1 wt % to 10 wt %.

In accordance with yet another embodiment, the QSE forms an interfacial passivation layer on at least one of the positive electrode and the negative electrode.

In accordance with yet another embodiment, the precursor mixture further comprises a radical-scavenging monomer configured to improve thermal stability of the battery.

In accordance with yet another embodiment, the monomers constitute from 0.5 wt % to 5 wt % of the precursor mixture.

In accordance with a second aspect of the present invention, a method of forming the lithium-based battery with QSE is provided. The method includes the following steps: introducing a precursor mixture including monomers and a liquid electrolyte into an assembled battery cell including a positive electrode, a separator, and a negative electrode; allowing the precursor mixture to infiltrate the electrodes and separator; and curing the precursor mixture by thermal curing or radiation curing to form a QSE having a solids content of 10 wt % or less and a liquid content of 90 wt % or more. It is worth noting that the precursor mixture has a viscosity of less than 10 cP and a surface tension of less than 25 mN/m prior to curing.

In accordance with one embodiment, the monomers comprise a fluoro-moiety-containing monomer and a monomer having multiple cross-linkable arms.

### BRIEF DESCRIPTION OF THE DRAWINGS

Embodiments of the invention are described in more details hereinafter with reference to the drawings, in which:

FIG. 1 depicts a graph of battery capacity vs. the number of battery cycles;

FIG. 2 depicts a graph of discharge capacity vs. cycling number;

FIG. 3 depicts a graph of discharge capacity vs. cycling number;

FIG. 4 depicts a graph of discharge capacity vs. cycling number;

FIG. 5 depicts is a graph of battery retention vs. cycling number; and

FIG. 6 depicts is a graph of discharge capacity vs. cycling number.

### DETAILED DESCRIPTION

In the following description, lithium batteries with novel QSE and/or fabrication methods thereof and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

As used herein, the term “quasi-solid-state electrolyte (QSE)” refers to an electrolyte system that comprises a polymer or gel matrix containing a liquid electrolyte component, wherein the liquid phase is immobilized or confined within the polymeric or crosslinked network so as to provide mechanical stability similar to a solid electrolyte while maintaining ionic conductivity comparable to that of liquid electrolytes.

In typical implementations, a QSE is formed by in-situ polymerization or gelation of liquid monomers or polymer precursors containing lithium salts and solvents, thereby producing a semi-solid structure that: retains a limited amount of liquid phase for efficient ion transport; exhibits reduced leakage and flammability compared with conventional liquid electrolytes; and provides improved interfacial contact with electrode materials relative to fully solid electrolytes.

The present invention concerns low-viscosity, in-situ curable electrolyte precursor systems that form gel or quasi-solid polymer electrolytes for improving electrode wetting, cycling stability, rate performance, and safety in lithium-ion and lithium-metal battery systems.

The precursor mixture of the present invention is characterized by a low viscosity, which provides several significant technical advantages. Specifically, the low viscosity enables rapid and uniform infiltration of the precursor mixture into porous electrode structures and separators prior to curing, thereby ensuring intimate interfacial contact between the electrolyte and active electrode materials. Such uniform wetting minimizes the formation of voids or poorly wetted regions that would otherwise increase interfacial resistance and hinder ionic transport. As a result, the cured quasi-solid-state electrolyte forms a continuous ion-conducting network throughout the electrode architecture, leading to improved rate capability, higher capacity utilization, and enhanced cycling stability. In addition, the improved infiltration enabled by the low-viscosity precursor mixture is particularly beneficial for thick and high-loading electrodes, where conventional higher-viscosity precursors fail to penetrate effectively, thereby enabling the fabrication of high-energy-density batteries without sacrificing electrochemical performance.

In accordance with a first aspect of the present invention, lithium batteries with novel QSE are provided. The QSE has low viscosity and surface tension properties, thereby enabling improved wetting of battery electrodes and ensuring more complete utilization of electrode capacity. To form the QSE, a thermally curable or radiation-curable precursor mixture is prepared. The precursor mixture comprises (i) monomers containing fluorinated moieties, (ii) monomers having multiple crosslinkable functional groups, and (iii) a lithium-containing electrolyte including one or more lithium salts dissolved in one or more solvents.

Upon uniform curing, the QSE formulation forms a stable polymeric interfacial layer on the surfaces of active electrode materials, thereby mitigating parasitic side reactions while preserving ionic transport pathways. This passivation effect significantly improves high-temperature cycling stability and may extend cycle life by approximately 50% to 200% relative to batteries employing conventional liquid electrolytes.

Monomers containing fluorinated moieties that are effective in reducing viscosity and surface tension include, for example, TFEA, TFMA, HFOMA, HFPA, QFMA, TFPMA, PFPMA, DFHA, HFBMA, TFOA, or mixtures thereof.

The fluorinated monomers are combined with multifunctional crosslinkable monomers to form a mechanically stable polymer network. Suitable multifunctional monomers include, for example, PEGDA, PEGMA, BABE, TEGDMA, PEGDMA, MBA, AA, PETA, BDMPEA, TMPTMA, TMPTA, TMPETA, TAEP, TAP, TADEP, DPTPHA, CPHEA, A-POSS, or mixtures thereof. In certain embodiments, the total monomer content is present at approximately 0.1% to 10% by weight of the precursor mixture, thereby allowing retention of a relatively high fraction of liquid electrolyte to enhance ionic conductivity and rate performance.

A key limitation in prior-art QSE formulations is the relatively high viscosity and surface tension of conventional monomers, which hinder effective electrode wetting prior to curing. For example, PEGDA exhibits a viscosity of approximately 86.9 cP and a surface tension of 40.84 mN/m, while TMPETA exhibits a higher viscosity of approximately 261 cP and a surface tension of 40.23 mN/m. Such high viscosities impede penetration of the precursor mixture into thick and dense electrode structures, resulting in non-uniform polymerization and reduced ionic transport efficiency.

In contrast, the present invention incorporates fluorinated monomers having significantly lower viscosity and surface tension, thereby enabling improved electrode wetting prior to curing. For example, TFEA, a representative component of the disclosed QSE formulation, has a viscosity of approximately 0.8 cP and a surface tension of about 20.13 mN/m. This reduction in viscosity and surface tension facilitates rapid and substantially complete electrolyte infiltration into electrode structures, ensuring more homogeneous polymerization and improved ionic transport. In certain embodiments, the precursor mixture is formulated to exhibit a viscosity of about 10 cP or less and a surface tension of about 25 mN/m or less. As a result, the present invention enables quasi-solid-state batteries exhibiting higher energy density, improved cycling stability, and enhanced rate performance.

After curing, the quasi-solid-state electrolytes of the present invention exhibit a gel-like structure that maintains continuous interfacial contact with both positive and negative electrodes during charge and discharge operation. As used herein, the term “gel” refers to a semi-solid material comprising a liquid phase confined within a cross-linked polymer matrix, wherein the polymer network provides mechanical stability while permitting ionic transport through the liquid phase. The gel maintains structural integrity without complete fluidity, thereby enabling its function as an electrolyte medium in lithium battery systems. In certain embodiments, the gel contains a predominant proportion of liquid electrolyte, typically about 90% or more by weight, and a polymeric solid content of about 10% or less, with the liquid electrolyte retained within the cross-linked polymer mesh. Owing to the affinity between the polymer network and the liquid electrolyte, the electrolyte remains encapsulated within the polymer structure while remaining available for ion transport, thereby contributing to improved cycling performance and retention of electrochemical properties at elevated temperatures. Although the electrolyte exhibits a gel-like state, the terms “liquid” and “solid” are used herein to describe the microstructural components of the material rather than macroscopically separable phases.

The improved QSE compositions further demonstrate high-rate discharge capability, achieving performance comparable to liquid-electrolyte batteries even at discharge rates of approximately 2 C. Such high-rate performance is particularly advantageous for batteries employing thick and dense electrodes, where conventional QSE systems typically exhibit significant rate limitations.

Additionally, the novel QSE composition provides enhanced high-temperature stability. By optimizing monomer selection, the QSE forms a more uniform and continuous passivation layer on battery active materials, thereby minimizing undesirable side reactions with the liquid electrolyte. Experimental results demonstrate that batteries incorporating the disclosed QSE exhibit significantly extended cycle life at 45° C., surpassing comparable liquid-electrolyte batteries by approximately 50% to 200%.

In a further aspect, the quasi-solid-state electrolytes of the present invention may include additives configured to improve battery safety. In certain embodiments, radical-scavenging functional groups are incorporated into the polymer matrix, thereby suppressing fire-inducing radical chain reactions during thermal runaway events. Consequently, batteries incorporating radical-scavenging monomers exhibit improved thermal stability and are capable of passing stringent safety tests, such as a 150° C. hotbox test, whereas conventional liquid-electrolyte batteries typically fail at approximately 120° C.

Unlike conventional flame-retardant additives that may introduce undesirable electrochemical side reactions, the radical-scavenging functional groups of the present invention are immobilized within the polymer matrix and remain substantially electrochemically inactive under normal operating conditions, while effectively suppressing radical-driven thermal runaway. Monomers containing fluorinated and phosphorus-containing moieties exhibit particularly strong radical-scavenging properties and provide enhanced safety performance.

Examples of phosphate-based monomers include tri(acryloyloxyethyl) phosphate (TAEP) and diethyl vinylphosphonate (DEVP). In certain embodiments, the phosphate-containing monomer also contains fluorinated moieties, while in other embodiments it is provided as a separate monomer component. Formulations containing such monomers have demonstrated improved safety performance, including successful operation in a 150° C. hotbox test compared with liquid-electrolyte batteries that typically fail at approximately 120° C.

Additional examples of monomers suitable for incorporation into the QSE precursor mixtures include GCA, TMSMA, TMSPA, MA-POSS, DAP, DEVP, EGMEA, PEGMEA, PEGMAMA, CEA, AAEM, DMAAm, or mixtures thereof.

The precursor mixtures of the present invention may be cured using a variety of techniques, including thermal curing, radiation curing, and electron-beam curing. For thermal curing, a thermal polymerization initiator may be included, such as one or more of AIBN, ACHBN, AMPN, CMAB, ADMVN, BPO, TPBO, CHPO, DPO, LPO, TBPBO, DTBADB, BTBTMO, TBECO, or TPP. In certain embodiments, the thermal polymerization temperature is approximately 70° C. or lower.

Alternatively, radiation polymerization initiators may be used for ultraviolet (UV) curing, including one or more of HMPP, APO, BPHO, DAPO, CPQO, DMPPO, HCPO, DPTPP, or PTBPPO.

When curing is performed using X-ray or gamma-ray irradiation, polymerization initiators may not be required. In such embodiments, irradiation levels may range from about 1 kGy to about 100 kGy.

An important component of the QSE compositions of the present invention is the liquid electrolyte. Because the QSE contains a relatively low polymer fraction, a substantial amount of liquid electrolyte can be retained within the polymer matrix to form a gel-like electrolyte structure. Suitable liquid electrolytes include compositions containing one or more lithium-containing salts dissolved in one or more solvents. Examples of lithium-containing salts include LiPF₆, LiTFSI, LiFSI, LiBF₄, LiBOB, LIDFOB, LiPO₂F₂, lithium nitrate, LiOTf, and LTFOP.

Solvents suitable for dissolving the lithium salts and optional additives include one or more of EC, PC, DMC, DEC, EMC, FEC, VC, DME, 2-DMP, DEE, 1,3-DMP, DMM, diglyme (G2), triglyme (G3), or G4.

The quasi-solid-state electrolytes of the present invention are suitable for use in lithium-ion batteries comprising lithium-containing positive electrodes optionally disposed on metallic current collectors.

The positive electrode active material may include one or more of lithium iron phosphate, lithium cobalt oxide, lithium nickel cobalt manganese oxide, lithium nickel cobalt aluminum oxide, spinel-type lithium manganese oxide, spinel-type lithium nickel manganese oxide, lithium-rich manganese oxide, or mixtures thereof.

The negative electrode may include carbon-based or silicon-containing materials optionally disposed on a metallic current collector, such as copper. Examples include hard carbon anodes, graphite anodes, silicon-carbon composite anodes, or mixtures thereof.

In alternative embodiments, the negative electrode may include lithium metal optionally disposed on a metallic current collector.

The improved QSE formulations demonstrate performance characteristics comparable to liquid-electrolyte batteries while providing enhanced safety. For example, batteries incorporating the disclosed QSE exhibit comparable rate performance at discharge currents up to approximately 2 C for at least 500 cycles, with capacity retention exceeding approximately 95%. Stable cycling is also observed at elevated temperatures (e.g., 45° C., or 3-50° C.), extending cycle life by at least approximately 50% to 200% compared to conventional liquid-electrolyte batteries.

Battery safety is further improved through enhanced fire resistance resulting from the incorporation of radical-scavenging monomers, enabling batteries to pass stringent safety tests at temperatures of approximately 150° C.

Furthermore, the optimized monomer selection contributes to formation of a uniform passivation layer on electrode active materials, thereby reducing electrolyte decomposition and further improving high-temperature cycling stability, with cycle life at 45° C. extended by approximately 50% to 200% relative to conventional liquid-electrolyte systems.

In accordance with a second aspect of the present invention, a method of fabricating the aforementioned lithium-based battery is provided. The method begins with introducing a precursor mixture into an assembled battery cell that includes a positive electrode, a separator, and a negative electrode. The precursor mixture includes monomers and a liquid electrolyte and is formulated to exhibit a viscosity of less than 10 cP and a surface tension of less than 25 mN/m prior to curing. These rheological properties enable the precursor mixture to readily infiltrate the porous structures of the electrodes and the separator, thereby ensuring uniform wetting and intimate interfacial contact throughout the cell architecture. After the precursor mixture has sufficiently infiltrated the electrodes and separator, the mixture is subjected to curing, which may be performed by thermal curing or radiation curing, thereby forming a QSE within the battery cell. The resulting cured electrolyte possesses a solids content of 10 wt % or less and a liquid content of 90 wt % or more. In some embodiments, the monomers contained in the precursor mixture include a fluoro-moiety-containing monomer in combination with a monomer having multiple cross-linkable arms, which together facilitate the formation of a cross-linked polymer network that retains the liquid electrolyte while maintaining effective ionic transport pathways.

### EXAMPLES

### Example 1. Electrochemical Performance Evaluation of Low-Monomer QSE

QSEs are prepared according to the parameters described above and incorporated into lithium batteries having various electrode compositions. The resulting batteries are compared with reference batteries employing prior-art thermally cured polymer electrolytes containing higher monomer percentages.

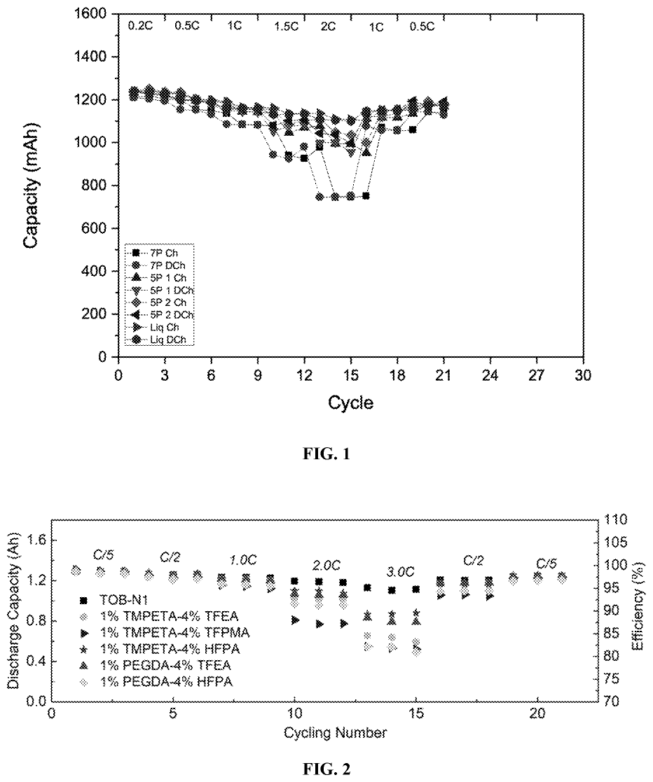

FIG. 1 illustrates electrolyte formulations of the present invention containing approximately 5% monomer content in comparison with prior-art compositions. The disclosed formulations enable effective curing at substantially lower monomer concentrations while maintaining structural integrity. Following curing, the batteries exhibit significantly improved rate performance, approaching that of liquid-electrolyte batteries. The rate-performance results are summarized in Table 1. The tested batteries include an NCM811 cathode, a graphite anode, and a polyolefin separator, and the QSE is cured by thermal initiation.

TABLE 1

| | | | 7% | | | | | |
|---|---|---|---|---|---|---|---|---|
| | | | Conventional | | 5% New | | 5% New | |
| | | Liquid | monomers | | monomers 1 | | monomers 2 | |
| 0.2 | C | 1228 | 1201 | (97.8%) | 1227 | (99.9%) | 1231 | (100%) |
| 1 | C | 1161 | 1083 | (93.3%) | 1146 | (98.7%) | 1155 | (99.4%) |
| 1.5 | C | 1132 | 949 | (83.8%) | 1070 | (94.6%) | 1096 | (96.8%) |
| 2 | C | 1105 | 747 | (67.7%) | 986 | (89.2%) | 1026 | (92.9%) |

FIG. 2 demonstrates that inclusion of the disclosed monomers in the QSE precursor compositions enables multiple formulations capable of curing at approximately 5% monomer loading, each exhibiting favorable rate performance comparable to a liquid-electrolyte reference battery (TOB-N1), including discharge performance up to 2 C. From these results, the optimal monomer combination may be identified based on 3 C discharge performance. The tested batteries comprised an NCM811 cathode, a graphite anode, and a polyolefin separator, and the QSE was cured by gamma-ray irradiation. Table 2 summarizes the corresponding battery-test results.

TABLE 2

| | | |
|---|---|---|
| Rate | 1 C | 2 C |

| | | |
|---|---|---|
| Liquid | 1.2339 | 1.1972 |

| | | | | |
|---|---|---|---|---|
| 1% TMPETA-4% TFEA | 1.2192 | (98.8%) | 1.021 | (85.3%) |
| 1% TMPETA- | 1.1561 | (93.7%) | 0.81 | (67.7%) |
| 4% TFPMA | | | | |
| 1% TMPETA- | 1.2166 | (98.6%) | 1.100 | (91.9%) |
| 4% HFPA | | | | |
| 1% PEGDA- | 1.2172 | (98.65%) | 1.067 | (89.1%) |
| 4% TFEA | | | | |
| 1% PEGDA- | 1.1664 | (94.5%) | 0.967 | (80.8%) |

4% HFPA

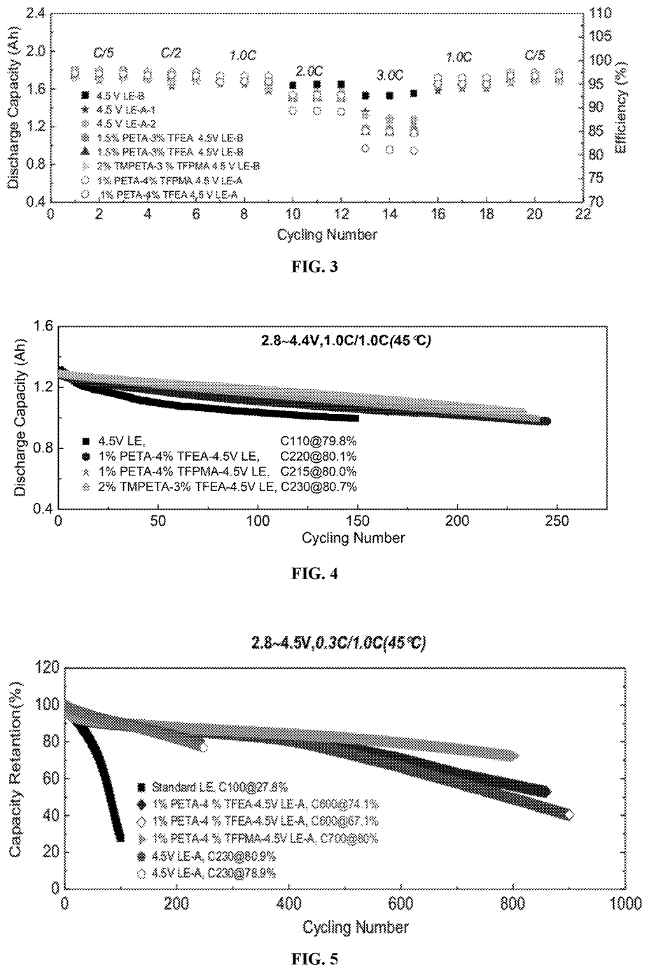

FIG. 3 presents performance results for batteries incorporating the disclosed monomer systems using an LCO cathode, a graphite anode, and a polyolefin separator, with the QSE cured by gamma-ray irradiation. The composition of the tested batteries is summarized in Table 3.

TABLE 3

| | Monomer | Monomer | | LE |
|---|---|---|---|---|
| Item | A | B | Initiator | (5 g) |
| 1 | PETA (1 wt %) | TFEA (4 wt %) | Gamma ray | 4.5 V |
| | | | | LE-A |
| 2 | PETA (1 wt %) | TFPMA (4 wt %) | Gamma ray | 4.5 V |
| | | | | LE-A |
| 3 | PETA (1.5 wt %) | TFEA (3 wt %) | Gamma ray | 4.5 V |
| | | | | LE-B |
| 4 | TMPETA (2 wt %) | TFEA (3 wt %) | Gamma ray | 4.5 V |
| | | | | LE-B |

FIG. 4 demonstrates that batteries incorporating the QSE compositions exhibit improved cycling performance compared with liquid-electrolyte batteries (4.5 V LE) under harsh cycling conditions (45° C., 1 C/1 C). This improvement is observed across multiple QSE monomer combinations. The tested batteries include an NCM811 cathode, a graphite anode, and a polyolefin separator, and the QSE is cured by gamma-ray irradiation. The composition of the tested batteries is summarized in Table 4.

TABLE 4

| | Monomer | Monomer | | LE |
|---|---|---|---|---|
| Item | A | B | Initiator | (5 g) |
| 1 | PETA (1 wt %) | TFEA (4 wt %) | Gamma ray | 4.5 V |
| | | | (70 kGy) | LE-B |
| 2 | PETA (1 wt %) | TFPMA (4 wt %) | Gamma ray | 4.5 V |
| | | | (70 kGy) | LE-B |
| 3 | PETA (1.5 wt %) | TFEA (3 wt %) | Gamma ray | 4.5 V |
| | | | (70 kGy) | LE-B |
| 4 | TMPETA (2 wt %) | TFEA (3 wt %) | Gamma ray | 4.5 V |
| | | | (70 kGy) | LE-B |

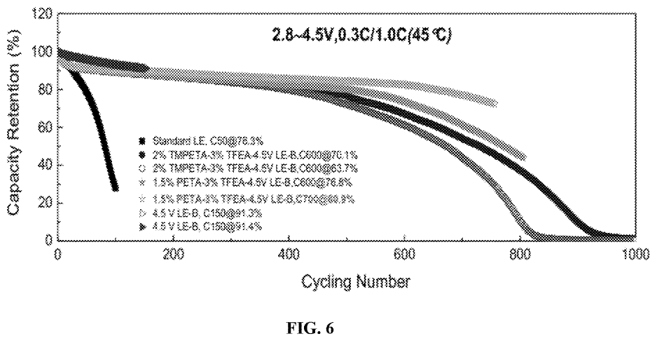

FIG. 5 further shows improved cycling performance for QSE-based batteries relative to liquid-electrolyte batteries (4.5 V LE) under harsh cycling conditions (45° C., 1 C/1 C) for batteries including an LCO cathode, a graphite anode, and a polyolefin separator, with the QSE cured by thermal initiation.

FIG. 6 illustrates enhanced cycling performance of QSE-based batteries compared with liquid-electrolyte batteries (4.5 V LE) under cycling conditions of 0.3 C/1 C. The tested batteries include an NCM811 cathode, a graphite anode, and a polyolefin separator, and the QSE is cured by thermal initiation.

As used herein, the term ‘comparable’ refers to a value that is equal to or within +10% of a referenced value unless otherwise specified; and the term “at least equal to” means equal to or greater than a specified value, amount, or condition.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A lithium-based battery, comprising:
a negative electrode;
a separator;
a positive lithium-containing electrode; and
a quasi-solid-state electrolyte (QSE) comprising an in-situ thermally or radiation-cured precursor mixture comprising monomers and a liquid electrolyte;
wherein the monomers comprise a fluoro-moiety-containing monomer and a monomer having multiple cross-linkable arms;
wherein the precursor mixture has a viscosity of less than 10 centipoise (cP) and a surface tension of less than 25 mN/m prior to curing such that the precursor mixture fully wets and infiltrates the negative electrode, the positive electrode, and the separator prior to curing;
wherein the cured electrolyte has a solids content of 10 wt % or less and a liquid content of 90 wt % or more;
wherein the lithium-based battery exhibits cycling stability during charge-discharge operation at 40-50° C.;
wherein the QSE provides at least equal cycling performance compared to liquid-electrolyte batteries at room temperature for 500 cycles; and
wherein the QSE provides comparable rate performance to liquid-electrolyte batteries at up to a 2 C discharge current with greater than 95% capacity retention.

2. The lithium-based battery of claim 1, wherein the positive electrode comprises one or more of lithium iron phosphate, lithium cobalt oxide, lithium nickel cobalt manganese oxide, lithium nickel cobalt aluminum oxide, spinel-based lithium manganese oxide, spinel-based lithium nickel manganese oxide, or lithium-rich manganese oxide.

3. The lithium-based battery of claim 1, wherein the negative electrode comprises one or more of carbon, graphite, or silicon-carbon.

4. The lithium-based battery of claim 1, wherein the negative electrode comprises lithium metal.

5. The lithium-based battery of claim 1, wherein the precursor mixture further comprises one or more flame retardant phosphate-including monomers.

6. The lithium-based battery of claim 1, wherein the radiation curing comprises gamma-ray irradiation or X-ray irradiation.

7. The lithium-based battery of claim 1, wherein the liquid electrolyte comprises one or more lithium salts dissolved in one or more solvents.

8. The lithium-based battery of claim 7, wherein the one or more solvents comprises one or more of ethylene carbonate (EC), propylene carbonate (PC), dimethyl carbonate (DMC), diethyl carbonate (DEC), ethyl methyl carbonate (EMC), fluoroethylene carbonate (FEC), vinylene carbonate (VC), 1,2-dimethoxyethane (DME), 1,2-dimethoxypropane (1,2-DMP), 1,2-diethoxyethane (DEE), 1,3-dimethoxypropane (1,3-DMP), dimethoxymethane (DMM), diethyleneglycol dimethylether (diglyme or G2), triethyleneglycol dimethylether (triglyme or G3), or tetraethyleneglycol dimethylether (G4).

9. The lithium-based battery of claim 7, wherein the lithium salt comprises one or more of lithium hexafluorophosphate (LiPF₆), lithium bis(trifluoromethanesulfonyl)imide (LiTFSI), lithium bis(fluoromethanesulfonyl)imide (LiFSI), lithium tetrafluoroborate (LiBF₄), lithium bis(oxalate) borate (LiBOB), lithium difluoro (oxalate) borate (LiDFOB), lithium difluorophosphate (LiPO₂F₂), lithium nitrate, lithium trifluoromethanesulfonate (LiOTF), or lithium tetrafluoro oxalato phosphate (LTFOP).

10. The lithium-based battery of claim 1, wherein the precursor mixture further comprises a thermal polymerization initiator comprising one or more of 2,2′-azobis(2-methylpropionitrile) (AIBN), 1,1′-azobis(cyclohexanecarbonitrile) (ACHBN), 2,2′-azobis(2-methylpropionitrile) (AMPN), 2-(1-cyano-1-methylethyl) azocarboxamide (CMAB), 2,2′-azobis(2,4-dimethylvaleronitrile) (ADMVN), benzoyl peroxide (BPO), tert-butyl peroxide (TPBO), cumene hydroperoxide (CHPO), dicumyl peroxide (DPO), lauroyl peroxide (LPO), tert-butyl peroxybenzoate (TBPBO), di-tert-butyl acetylenedicarboxylate (DTBADB), 1,1-bis(tert-butylperoxy)-3,3,5-trimethylcyclohexane (BTBTMO), tert-butylperoxy 2-ethylhexyl carbonate (TBECO), or tetrabutylphosphonium Persulfate (TPP).

11. The lithium-based battery of claim 1, wherein the precursor mixture further comprises a UV-polymerization initiator comprising one or more of 2-hydroxy-2-methylpropiophenone (HMPP), acetophenone (APO), benzophenone (BPHO), 2,2-diethoxyacetophenone (DAPO), camphorquinone (CPQO), 2,2-dimethoxy-2-phenylacetophenone (DMPPO), 1-hydroxycyclohexyl phenyl ketone (HCPO), ipdhenyl (2,4,6-trimethylbenzoyl)phosphine oxide (DPTPP), or phenylbis (2,4,6-trimethylbenzoyl) phosphine oxide (PTBPPO).

12. The lithium-based battery of claim 1, wherein the fluoro-moiety-containing monomer comprises one or more of 2,2,2-trifluoroethyl acrylate (TFEA), 2,2,2-trifluoroethyl methacrylate (TFMA), 2,2,3,4,4,4-hexafluorobutyl methacrylate (HFOMA), 1,1,1,3,3,3-hexafluoroisopropyl acrylate (HFPA), 2,2,3,3,4,4,5,5-octafluoropentyl methacrylate (QFMA), 2,2,3,3-tetrafluoropropyl methacrylate (TFPMA), 2,2,3,3,3-pentafluoropropyl methacrylate (PFPMA), 2,2,3,3,4,4,5,5,6,6,7,7-dodecafluoroheptyl acrylate (DFHA), 2,2,3,3,4,4,4-heptafluorobutyl methacrylate (HFBMA), or 3,3,4,4,5,5,6,6,7,7,8,8,8-tridecafluorooctyl acrylate (TFOA).

13. The lithium-based battery of claim 1, wherein the monomer having multiple cross-linkable arms comprises one or more of poly(ethylene glycol) diacrylate (PEGDA), poly(ethylene glycol) methacrylate (PEGMA), 1,4-bis(acryloyloxy) butane (BABE), triethylene glycol dimethacrylate (TEGDMA), poly(ethylene glycol) dimethacrylate (PEGDMA), N,N′-methylenebis(acrylamide) (MBA), acrylic anhydride (AA), pentaerythritol tetraacrylate (PETA), 2-((bis((2-oxo-1,3-dioxolan-4-yl) methoxy)phosphoryl)oxy)ethyl acrylate (BDMPEA), trimethylolpropane trimethacrylate (TMPTMA), trimethylolpropane triacrylate (TMPTA), trimethylolpropane ethoxylate triacrylate (TMPETA), tri(acryloyloxyethyl) phosphate (TAEP), triallyl phosphate (TAP), tris(acryloyldioxyethyl) phosphate (TADEP), dipentaerythritol penta-/hexa-acrylate (DPTPHA), ((1,3,5,2λ5,4λ5,6λ5-triazatriphosphinine-2,2,4,4,6,6-hexayl)hexakis(oxy))hexakis(ethane-2,1-diyl) hexaacrylate (CPHEA), or acrylo POSS (A-POSS).

14. The lithium-based battery of claim 1, wherein the precursor mixture further comprises one or more of (2-oxo-1,3-dioxolan-4-yl)methyl methacrylate (GCA), 3-(trimethoxysilyl) propyl methacrylate (TMSMA), 3-(trimethoxysilyl) propyl acrylate (TMSPA), methacrylpropylisobutyl POSS (MA-POSS), diethyl allyl phosphate (DAP), diethyl vinylphosphonate (DEVP), 2-methoxyethyl acrylate (EGMEA), poly(ethylene glycol) methyl ether acrylate (PEGMEA), poly(ethylene glycol) methyl ether methacrylate (PEGMAMA), 2-cyanoethyl acrylate (CEA), 2-(methacryloyloxy)ethyl acetoacetate (AAEM), or N,N-dimethylacrylamide (DMAAm).

15. The lithium-based battery of claim 1, wherein the monomer concentration in the precursor mixture is from 0.1 wt % to 10 wt %.

16. The lithium-based battery of claim 1, wherein the QSE forms an interfacial passivation layer on at least one of the positive electrode and the negative electrode.

17. The lithium-based battery of claim 1, wherein the precursor mixture further comprises a radical-scavenging monomer configured to improve thermal stability of the battery.

18. The lithium-based battery of claim 1, wherein the monomers constitute from 0.5 wt % to 5 wt % of the precursor mixture.

19. A method of forming the lithium-based battery of claim 1, comprising:
introducing a precursor mixture comprising monomers and a liquid electrolyte into an assembled battery cell comprising a positive electrode, a separator, and a negative electrode;
allowing the precursor mixture to infiltrate the electrodes and separator; and
curing the precursor mixture by thermal curing or radiation curing to form a QSE having a solids content of 10 wt % or less and a liquid content of 90 wt % or more;
wherein the precursor mixture has a viscosity of less than 10 cP and a surface tension of less than 25 mN/m prior to curing.

20. The method of claim 19, wherein the monomers comprise a fluoro-moiety-containing monomer and a monomer having multiple cross-linkable arms.
